(19) United States
(12) Patent Application Publication
(10) Pub. No.: US 2020/0015653 A1
(43) Pub. Date: Jan. 16, 2020

(54) WATER SINK AND WASHING MACHINE HAVING THE SAME

(71) Applicant: Ningbo Mengo Kitchen Equipment Co., Ltd., NINGBO (CN)

(72) Inventor: HAIBIN MEI, NINGBO (CN)

(73) Assignee: Ningbo Mengo Kitchen Equipment Co., Ltd.

(21) Appl. No.: 16/507,651

(22) Filed: Jul. 10, 2019

(30) Foreign Application Priority Data
Jul. 11, 2018 (CN) 201821092597.7
Jun. 11, 2019 (CN) 201910500787.0

(51) Int. Cl. A47L 15/00; A47J 43/24

(52) U.S. Cl. CPC A47L 15/0086; E03C 1/182; A47J 43/24

(57) ABSTRACT

The invention discloses a water sink comprising a water sink body. The two opposite inner walls of the water sink body are equipped with a baffle, and two ends of the baffle are fixedly connected with the inner walls of the water sink body. Also, the invention discloses a sink-type washing machine with the above-described water sink and a washer. The water sink is integrated with the washing machine. The water sink has a storage structure, which can increase the storage capacity of the water sink and can store a cutting board, a drain basket, and the like within the water sink. The drained water directly flows into the water sink to keep the kitchen table clean.

### CROSS-REFERENCE TO RELATED APPLICATIONS

This application claims priority to Chinese Patent Application No. 201910500787.0 with a filing date of Jun. 11, 2019 and Chinese Patent Application No. 201821092597.7 with a filing date of Jul. 11, 2018. The content of the aforementioned applications, including any intervening amendments thereto, are incorporated herein by reference.

### TECHNICAL FIELD

The present invention relates to the field of water sink technology, and more particularly to a water sink and a washing machine having the same.

### BACKGROUND

The water sink is an indispensable part of every family kitchen. The vast majority of the existing water sinks are ordinary sinks which usually have two large and one small tanks for washing dishes and vegetables. The frequently used cutting boards, washing baskets, drain baskets, etc., are placed separately on a table top. This takes up a large space in the kitchen, and also makes the kitchen messy and untidy.

### SUMMARY

The technical problem to be solved by the present invention is to provide a water sink having a storage structure, which can increase the storage capacity of the water sink and can store a cutting board, a drain basket, and the like within the water sink. The drained water directly flows into the water sink to keep the kitchen table clean.

The technical solution of the present invention provides a water sink comprising a water sink body. Each of two opposite inner walls of the water sink body has a baffle, and both ends of the baffle are fixedly connected between the inner walls of the water sink body.

With the above structure, the water sink of the present invention has the following advantages compared to prior arts:

Since the opposite inner walls of the water sink body of the present invention are provided with a baffle, the two baffles can be used for arranging a cutting board, a drain basket, a drain board and the like. The cutting board can be drained directly in the water sink. Washed fruits, vegetables, etc., can also be placed directly in the drain basket or drain plate in the water sink for draining. Thus it allows keeping the tabletops clean and dry, and convenient for users and avoids wetting the tabletops.

In a preferred embodiment, space is left between the baffle and the inner wall of the corresponding water sink body. By adopting such a structure, the space between the baffle and the inner wall of the water sink can be used for inserting tools, hanging hooks and the like, which is more convenient for the user and further enhances the storage capacity of the water sink.

In a preferred embodiment, a slot for inserting a cutting board is formed between one end or both ends of the baffle and the side wall of the water sink body adjacent to an end surface of the one end or both ends. With this structure, the cutting board placed on the baffle can be inserted into the slot after use, and it is more convenient to store the cutting board.

In a preferred embodiment, each of a front inner wall and a rear inner wall of the water sink body comprises the baffle. Within such a structure, the baffles are arranged on the front and rear inner walls. It is more convenient for the user to use such a water sink.

In a preferred embodiment, both ends of the baffle and the inner wall of the water sink body are fixedly connected by a connecting member. This embodiment allows for a simple structure and easier connection.

In a preferred embodiment, the baffle is in a “U” shape, and both ends of the baffle are respectively fixedly connected to the inner walls of the water sink body through a locking member. This embodiment allows for one-piece molding, and more simple and reliable structure

In a preferred embodiment, the baffle comprises a support rod and a connecting portion respectively disposed at each end of the support rod, the connecting portion is fixedly connected to the inner wall of the water sink body, a corner is arranged between the end of the support rod and the connecting portion, the outer side of the corner is a curved surface, and the inner side of the corner is a right angle. With this structure, the outer side of the corner is a curved surface to avoid injuring people.

In a preferred embodiment, the baffle comprises a support rod and a connecting portion respectively disposed at each end of the support rod, the connecting portion is fixedly connected to the inner wall of the water sink body, the connecting portion is perpendicular to an end of the support rod, a side of the support rod away from the connecting portion comprises a protrusion, a cross section of the protrusion is in a triangular shape, and each of the both ends of the protrusion has a triangular slope. With such a structure, the cross section of the protrusion would have a triangular shape, which can effectively reduce the volume of the baffle and increase the internal space of the water sink.

In a preferred embodiment, both ends of the baffle are arched surfaces, the baffle includes a support rod and a connecting portion provided at both ends of the support rod, the connecting portion is fixedly connected to the inner wall of the water sink body, and the connecting portion is perpendicular to the end of the support rod. With this structure, the two ends of the baffle would have curved surfaces to avoid injuring people.

In a preferred embodiment, the baffle comprises a support rod and a connecting portion respectively disposed at each end of the support rod, the connecting portion is fixedly connected to the inner wall of the water sink body, a corner is arranged between the end of the support rod and the connecting portion, the outer side of the corner is a slope, and the inner side of the corner is a right angle. After adopting such a structure, the outer side of the corner is a slope, which can effectively reduce the volume of the baffle and increase the internal space of the water sink.

In a preferred embodiment, the baffle comprises a support rod, each of the both ends of the support rod adjacent to the corresponding side wall of the inner wall of the water sink body comprises a connecting portion, and the connecting portion is detachably connected to the inner wall of the water sink body. Disassembly and assembly of the baffles can be performed according to the needs of users. The use of the baffle may be more flexible and convenient

In a preferred embodiment, the connecting portion has a socket on a side of the inner wall of the water sink body, the lower end of the socket has an opening, a socket block is disposed at a position on the inner wall of the water sink body corresponding to the socket, the support rod is suspended on the inner wall of the water sink body, and the socket is matched with the socket block. With such a structure, it is convenient to disassemble and the support rod.

In a preferred embodiment, the socket block has a dovetail shape in cross section, and the socket has a shape that matches the shape of the socket block.

In a preferred embodiment, each of the both ends of the support rod has an arched shape. This structure avoids injuring people

In a preferred embodiment, the baffle comprises a support rod, each of the both ends of the support rod adjacent to the corresponding side wall of the inner wall of the water sink body comprises a connecting portion, and the connecting portion is fixedly connected to the inner wall of the water sink body.

In a preferred embodiment, the baffle comprises a support rod, both ends of the support rod are fixed to the inner wall of the water sink body, and a gasket is disposed between the end of the support rod and the inner wall of the water sink body. Another technical problem to be solved by the present invention is to provide a sink-type washing machine comprising a water sink having a storage function, which can store a cutting board, a drain basket, and the like within, and the drained water directly flows into the water sink to keep the kitchen table clean and tidy.

The technical solution of the present invention further provides a sink-type washing machine comprising the water sink of any one of the embodiments and a washer. The water sink is integrated with the washer.

With the above structure, the water sink of the present invention has the following advantages as compared with the prior art: Since the sink-type washing machine of the present invention integrates a water sink and the opposite inner walls of the water sink body of the water sink may each comprise a baffle, the two baffles can be used for arranging a cutting board, a drain basket and a drain board. The cutting board can be washed directly in the water sink. The washed fruits and vegetables can also be directly placed in the drain basket or the drain board in the water sink for draining, so as to avoid wetting the tabletops and keep the tabletops clean and dry. It is more convenient for users to use.

In a preferred embodiment, the washing machine is a dishwasher or a fruit and vegetable washing machine

### BRIEF DESCRIPTION OF THE DRAWINGS

FIG. 1 is a schematic view showing the structure of a sink-type washing machine in accordance with a first embodiment of the present invention.

FIG. 2 is a schematic plan view showing the structure of the sink-type washing machine in accordance with a first embodiment of the present invention.

FIG. 3 is a schematic view showing the structure of a baffle of the sink-type washing machine according to a first embodiment of the present invention.

FIG. 4 is a perspective view showing the structure of a cutting board of the sink-type washing machine according to a first embodiment of the present invention.

FIG. 5 is a perspective view showing the other side of the cutting board of the sink-type washing machine in accordance with the first embodiment of the present invention.

FIG. 6 is a perspective view showing the structure of the cutting board of the sink-type washing machine of the first embodiment of the present invention with a panel removed.

FIG. 7 is a perspective view showing another perspective of the cutting board of the sink-type washing machine of the first embodiment of the present invention with the panel removed.

FIG. 8 is a perspective view showing the structure of a panel of a cutting board of a sink type washing machine according to a first embodiment of the invention.

FIG. 9 is a perspective view showing the structure of a water sink according to a second embodiment of the present invention.

FIG. 10 is a perspective view showing the structure of a baffle of the water sink of the second embodiment of the present invention.

FIG. 11 is an enlarged schematic view of a portion A of FIG. 9.

FIG. 12 is a perspective view showing the structure of a water sink according to a third embodiment of the present invention.

FIG. 13 is a perspective view showing the structure of a baffle of the water sink of the third embodiment of the present invention.

FIG. 14 is a schematic enlarged view of a portion B of FIG. 12.

FIG. 15 is a perspective view showing the structure of a water sink according to a fourth embodiment of the present invention.

FIG. 16 is a perspective view showing the structure of the baffle of a water sink of the fourth embodiment of the present invention.

FIG. 17 is a schematic enlarged view showing a portion C of FIG. 15.

FIG. 18 is a perspective view showing the structure of a water sink according to a fifth embodiment of the present invention.

FIG. 19 is a perspective view showing the structure of the baffle of a water sink of the fifth embodiment of the present invention.

FIG. 20 is a schematic enlarged view of a portion D of FIG. 19.

FIG. 21 is a perspective view showing the structure of the water sink of the fifth embodiment of the present invention with the baffle removed.

FIG. 22 is a schematic enlarged view of the portion E of FIG. 21.

FIG. 23 is a perspective view showing the structure of a plug block of a water sink according to a fifth embodiment of the present invention.

FIG. 24 is a perspective view showing the structure of a water sink according to a sixth embodiment of the present invention.

FIG. 25 is a perspective view showing the structure of a water sink of the sixth embodiment of the present invention.

FIG. 26 is an enlarged schematic view showing a portion F of FIG. 15.

FIG. 27 is a perspective view showing the structure of a water sink according to a seventh embodiment of the present invention.

FIG. 28 is a perspective view showing the structure of a water sink of the seventh embodiment of the present invention.

FIG. 29 is a schematic enlarged view showing a portion G of FIG. 15.

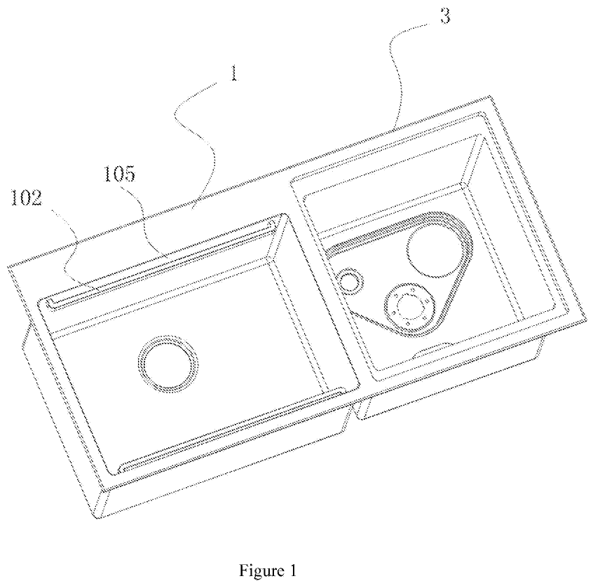

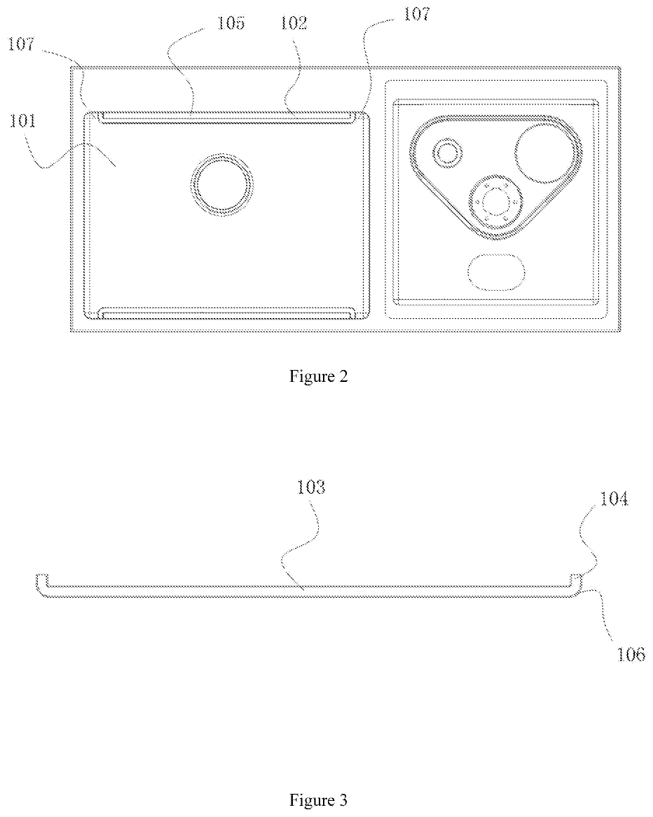

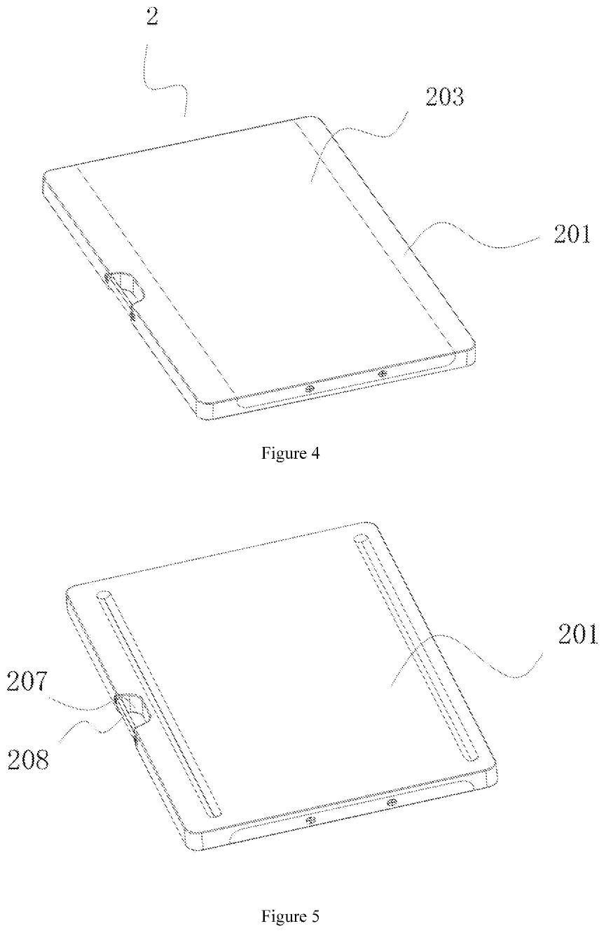

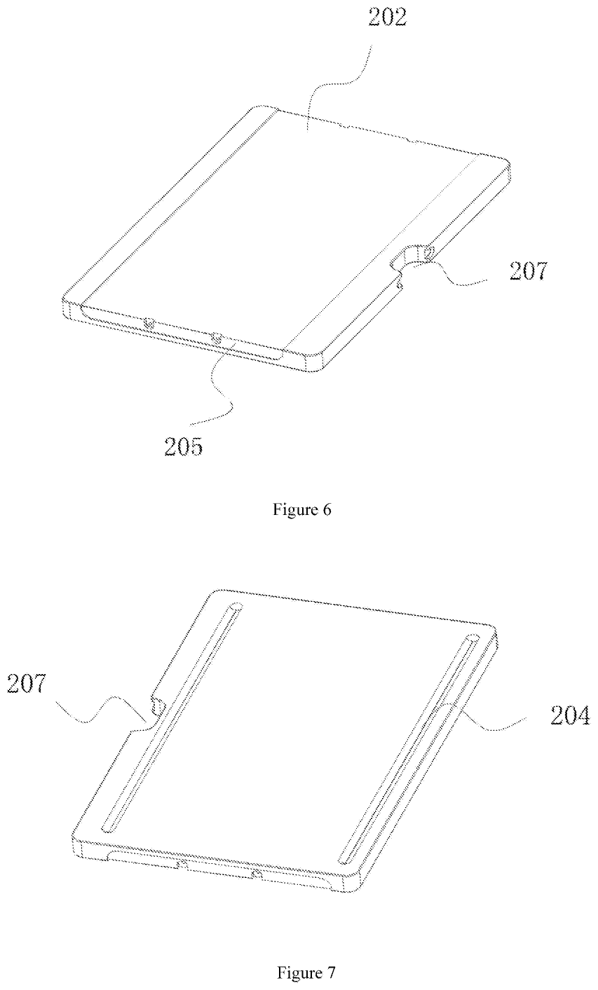

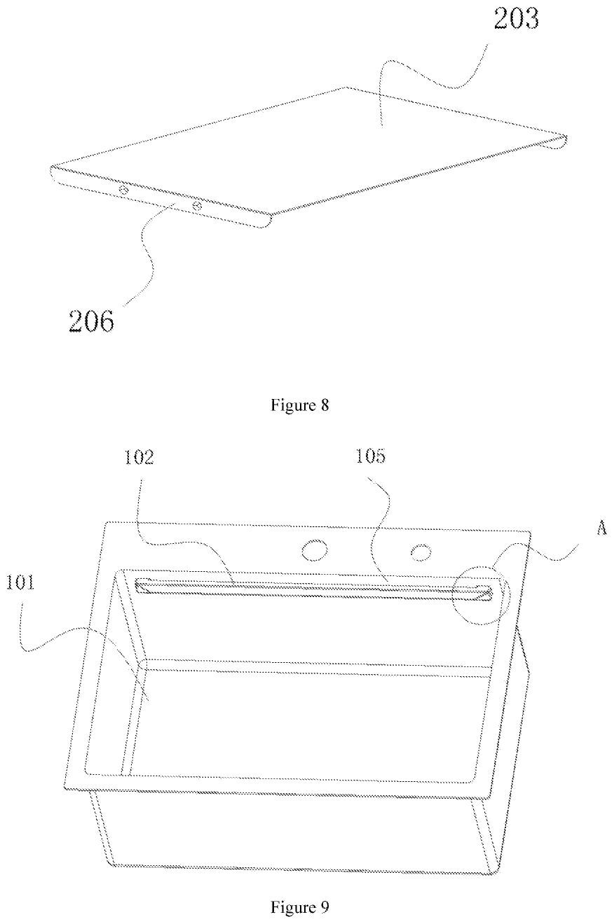

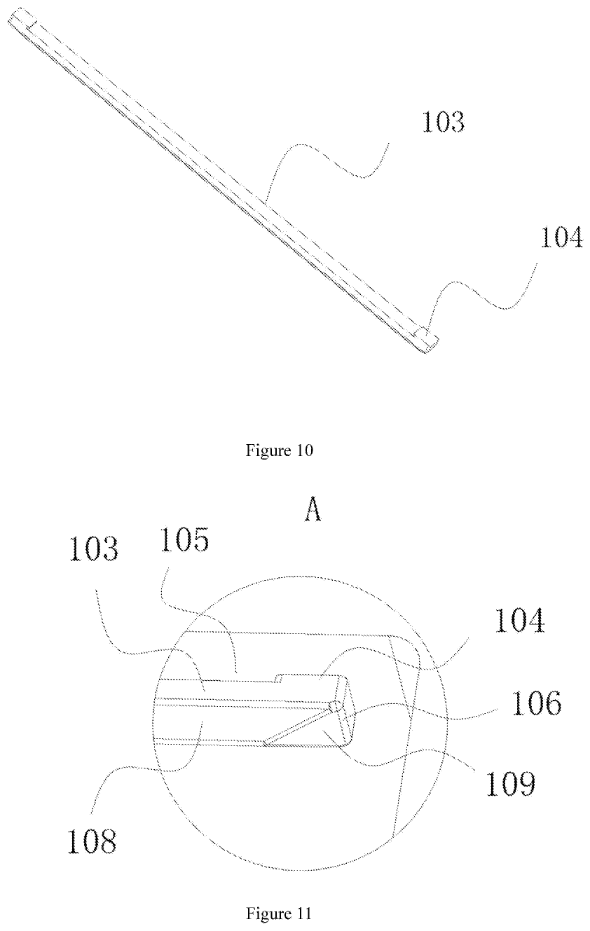

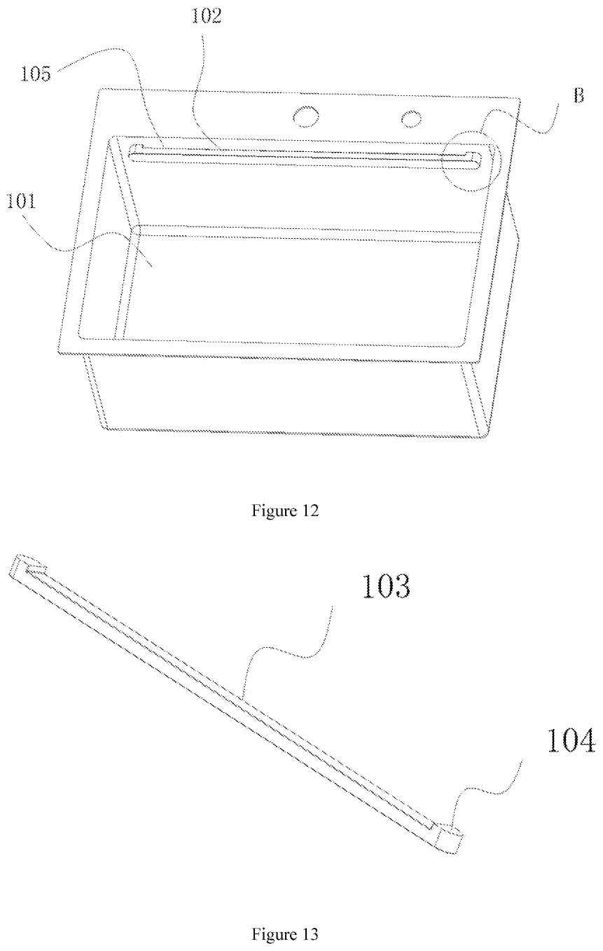

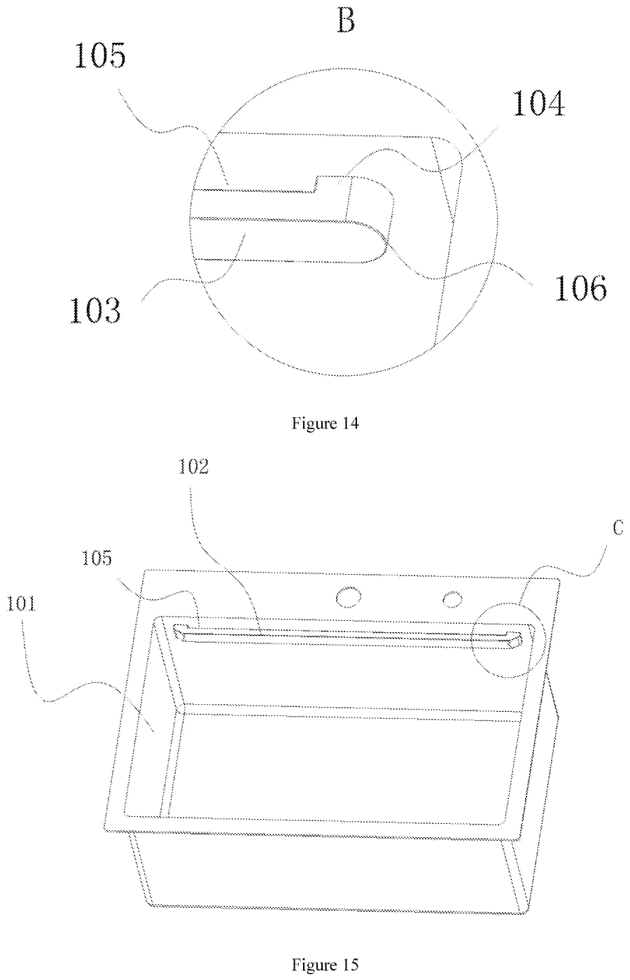

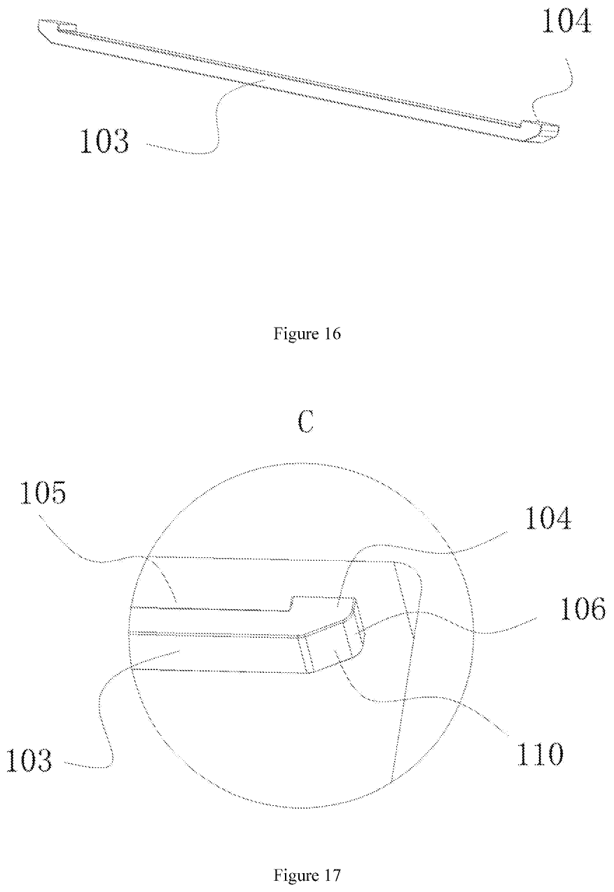

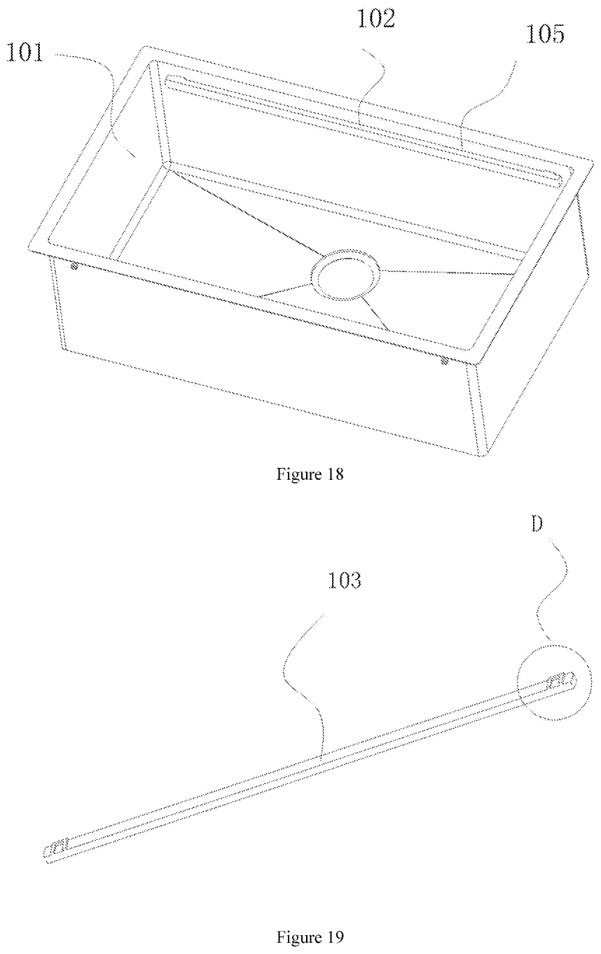

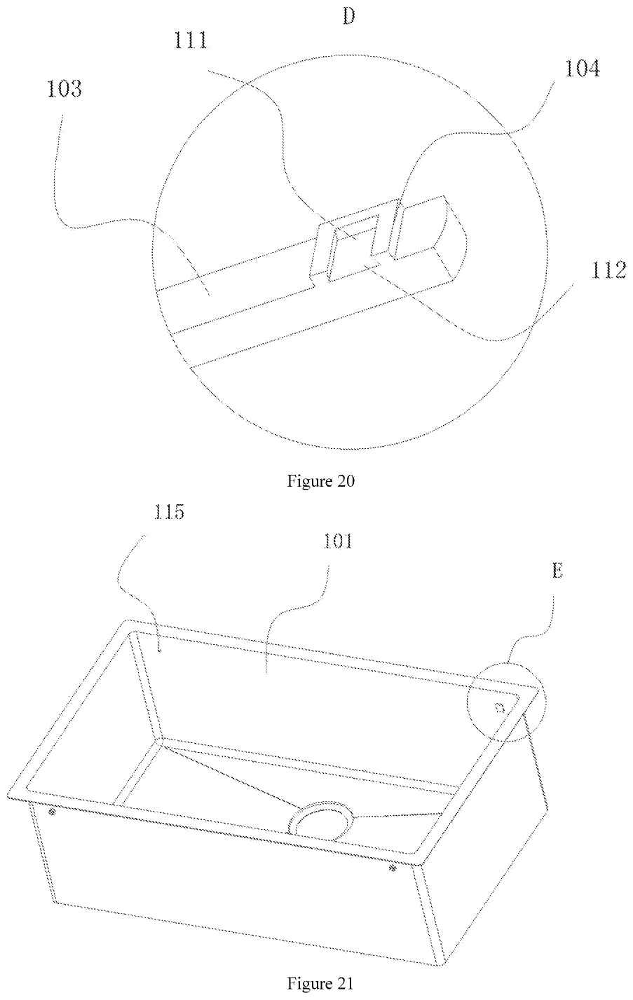

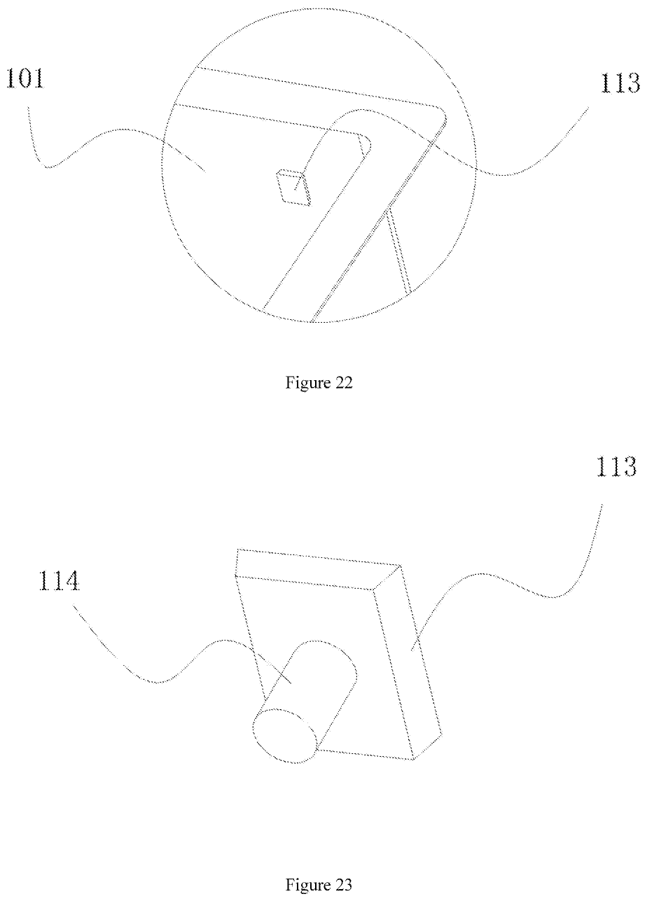

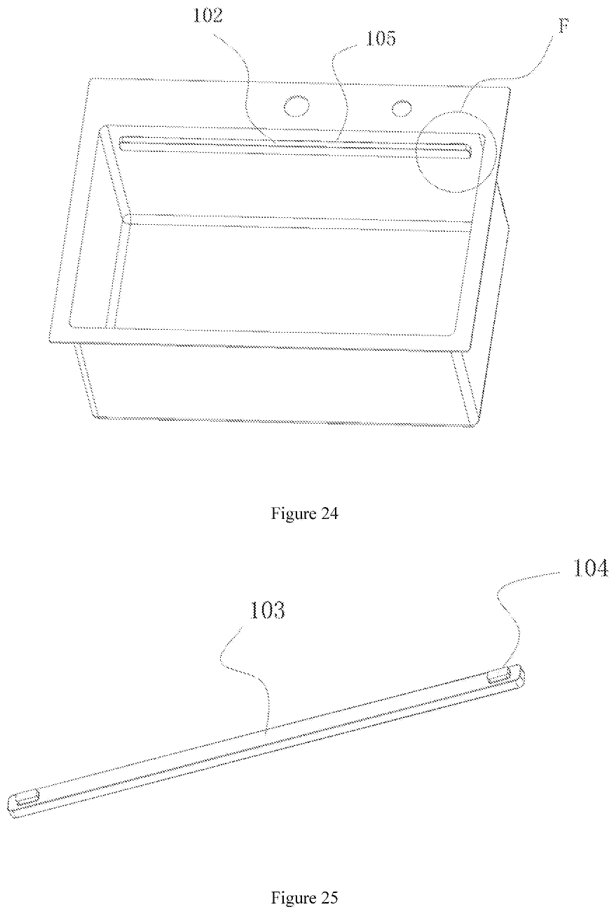

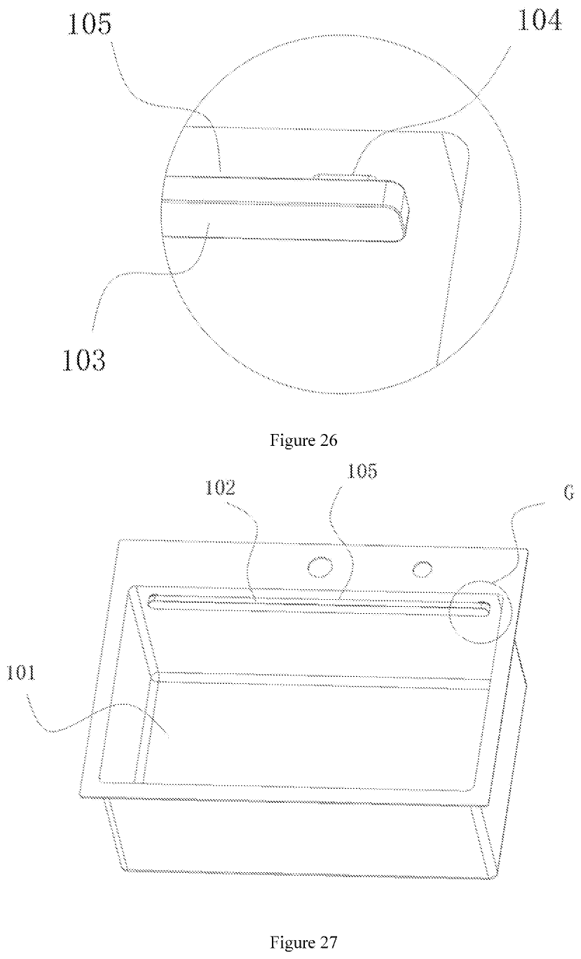

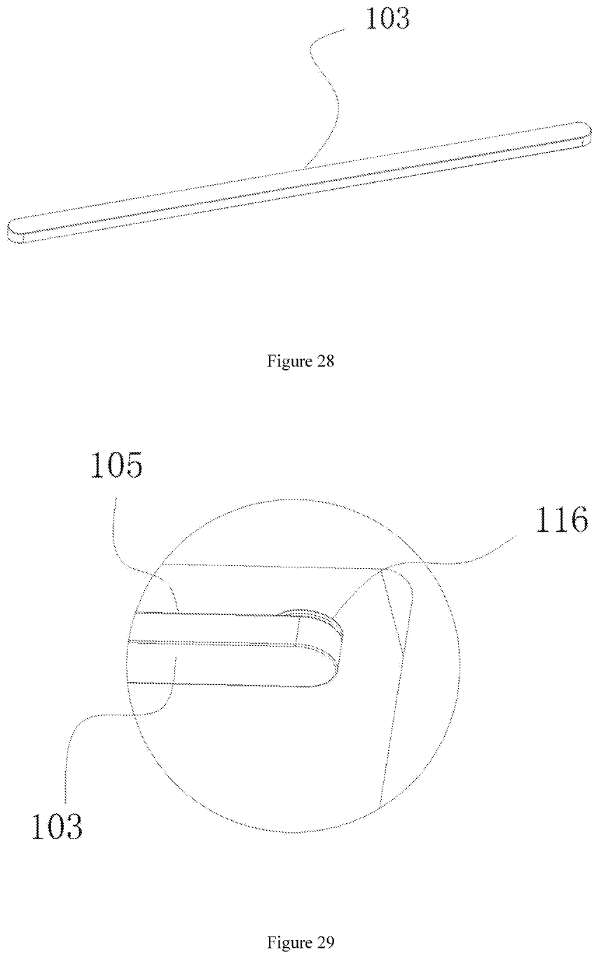

### REFERENCE NUMBERS

1. water sink, 101, water sink body, 102, baffle, 103, support rod, 104, connecting portion, 105, space, 106, corner, 107, slot, 108, protrusion, 109, triangular slope, 110, slope, 111, socket, 112, opening, 113, socket block, 114, screw rod, 115, mounting hole, 116, gasket, 2, cutting board, 201, cutting board body, 202, embedded slot, 203, panel, 204, groove, 205, extension groove, 206, bent portion, 207, handle groove, 208, handle, 3, washer.

### DETAILED DESCRIPTION

For a better understanding of the present application, various aspects of the present application will be described in more detail with reference to the accompanying drawings. It should he understood that the detailed description is only illustrative of the exemplary embodiments of the present application, and is not intended to limit the scope of the application. Throughout the specification, the same drawing reference numerals refer to the same elements.

In the drawings, the thickness, size, and shape of the object have been somewhat exaggerated for convenience of explanation. The drawings are only examples and not strictly drawn to scale.

It will also be understood that the terms “comprising”, “including”, “having”, “encompassing”, when used in the specification, suggest presence of the described features, integers, steps, operations, components, parts, but does not exclude the presence or addition of one or more other features, integers, steps, operations, components, parts and/or combinations thereof. Moreover, when expressions such as “at least two” appear after the list of listed features, the entire listed features are defined instead of the individual elements in the list.

### 1^{st} Embodiment

The present invention discloses a water sink 1 which includes a water sink body 101. The front inner wall and the rear inner wall of the water sink body 101 are each provided with a baffle 102, and the upper planes of both the front and rear bars 102 are aligned.

The baffle 102 is in a “U” shape. The baffle 102 includes a support rod 103 and connecting, portions 104 respectively disposed at each end of the support rod 103. The connecting portion 104 is fixedly connected to the inner wall of the corresponding water sink body 101. The inner wall of the water sink body 101 has a mounting hole (not shown) through which a screw is fixed to the end surface of the connecting portion 104. A sealing gasket (not shown) is disposed between the end surface of the connecting portion 104 and the inner wall of the water sink body 101 or/and between a nut of the screw and the outer wall of the water sink body 101, in order to prevent the mounting hole from a water leakage. Waterproof glue may be applied between the nut and the outer wall of the water sink body 101 to provide waterproofing. The connecting portion 104 may also be fixed to the inner wall of the water sink body 101 by welding.

A space 105 is left between the support rod 103 and the inner wall of the water sink body 101. The space 105 can be used to insert a tool, or to hang objects such as a drain rack, a hook, and the like.

A corner 106 is disposed between the end of the support rod 103 and the connecting portion 104. The outer side of the corner 106 is a curved surface, and the inner side of the corner 106 is a right angle. A slot 107 for inserting the cutting board is formed between the corner 106 and the inner wall of the adjacent water sink body 101. Therefore, a left slot is between the left end of the support rod 103 and the left side wall of the water sink body 101, and a right slot is between the right end of the support rod 103 and the right side wall of the water sink body 101. The width of the slot 107 matches the width of the cutting board 2. After the cutting board 2 is used, it can be inserted in the left slot or in the right slot. The minimum distance between the front and rear baffles 102 is less than the length of the cutting hoard 2 and the maximum distance between the front and rear baffles 102 is greater than the length of the cutting board 2, so that the two ends of the cutting board 2 can be placed on the two baffles 102 to cut vegetables and slid along the two strips baffle. The water on the cutting hoard 2 is directly dripped in the water sink without wetting the countertop.

The cutting board 2 includes a cutting board body 201. The cutting board body 201 is made of bamboo, wood or plastic. One side of the cutting board body 201 has an embedded slot 202, and the embedded slot 202 has a panel 203. Grooves 204 are provided on the edges of the two sides of the other side of the cutting board body 201. The grooves 204 are elongated. When the cutting board 2 is inserted into the slot 107, the side having the panel 203 is adjacent to the inner wall of the adjacent water sink body 101, and the side having the groves 204 is away from the inner wall. When the cutting board 2 is to be picked up, it can be picked up by inserting a finger into the grooves 204. It is convenient to pull the cutting board from the slot 107.

The two ends of the embedded slot 202 extend toward the side walls of the cutting board body 201 to form an extension groove 205. Each of the two ends of the panel 203 has a bent portion 206 matched with the extension groove 205. The bent portions 206 at the two ends of the panel 203 are fixed in one-to-one correspondence within the extension grooves 205 at the two ends of the cutting board body 201. The bent portions 206 at both ends of the panel 203 are fixed in the corresponding extension groove 205 by screws. The panel 203 is made of stainless steel or glass. If the cutting board body 201 is not plastic, the panel 203 may be made of plastic.

A handle groove 207 is disposed on one side of the cutting board body 201, and a handle 208 is disposed in the handle groove 207. The handle 208 is a horizontal bar, and the two ends of the horizontal bar are respectively connected to the two side walls of the handle groove 207. The outer side wall of the handle 208 is aligned with the outer side wall of the cutting board body of 201.

The invention also discloses a sink-type washing machine comprising the water sink 1 of the above structure and a washer 3. The water sink 1 is integrated with the washer 3. The water sink body 101 of the water sink 1 is fixedly connected to, i.e., integrally formed with the sink body of the washer 3. The washer 3 is a dishwasher or a fruit and vegetable washing machine.

### 2^{nd} Embodiment

The invention discloses a water sink 1 comprising a water sink body 101. The water sink 1 of the present embodiment is different from the water sink of the first embodiment in that:

The baffle 102 includes a support rod 103 and connecting portions 104 respectively disposed at each end of the support rod 103. The connecting portions 104 are fixedly connected to the inner wall of the water sink body 101. The connecting portion 104 is perpendicular to the end of the support rod 103. The side of the support rod 103 away from the connecting portion 104 has a protrusion 108, and the protrusion 108 has a triangular cross section. Both ends of the protrusion 108 are formed as triangular slopes 109.

### 3^{rd} Embodiment

The invention discloses a water sink 1 comprising a water sink body 101. The water sink 1 of the present embodiment is different from the water sink of the first embodiment in that:

The two ends of the baffle 102 are arched surfaces, and the baffle includes a support rod 103 and a connecting portion 104 disposed at an end of the support rod 103. The connecting portion 104 is fixedly connected to the inner wall of the water sink body 101. The connecting portion 104 and the end of the support rod 101 are perpendicular to each other.

### 4^{th} Embodiment

The invention discloses a water sink 1 comprising a water sink body 101. The water sink 1 of the present embodiment is different from the water sink of the first embodiment in that:

The baffle 102 includes a support rod 103 and a connecting portion 104 respectively disposed at each end of the support rod 103. The connecting portion 104 is fixedly connected to the inner wall of the water sink body 101. A corner 106 is disposed between the end of the support rod 103 and the connecting portion 104 The outer side of the corner 106 is a slope 110, and the inner side of the corner 106 is a right angle.

### 5^{th} Embodiment

The invention discloses a water sink 1 comprising a water sink body 101. The water sink of this embodiment differs from the water sink of the first embodiment in that:

The baffle 102 includes a support rod 103. Each of the two ends of the support rod 103 adjacent to the side wall of the inner wall of the corresponding water sink body 101 has a connecting portion 104. There is a certain distance between the end faces of the support rods 103. The end faces of both end portions of the support rod 103 are all arched shapes. The connecting portion 104 is detachably connected to the inner wall of the water sink body 101.

The side of the connecting portion 104 disposed near the inner wall of the water sink body 101 has a socket 111. The lower end of the socket 111 has an opening 112. A socket block 113 is disposed at a position corresponding to the socket 111 on the inner wall of the water sink body 101 is located on the inner wall of the water sink body 101. That means the socket block 113 is fixed on the inner wall of the water sink body 101, and a mounting hole 115 is provided on the inner wall of the water sink body 101. A screw 114 is disposed on the socket block 113. The screw 114 passes through the mounting hole 115. The end of the screw 114 is exposed outside the water sink body 101 and is locked through a nut (not shown). A sealing gasket (not shown) is disposed between the socket block 113 and the inner wall of the water sink body 101 and/or between the nut and the outer wall of the water sink body 101. The gasket prevents the mounting hole from a water leakage. The nut and the outer wall of the water sink body 101 may also be waterproofed with waterproof glue to provide waterproofing. The socket block 113 can also be fixed to the inner wall of the water sink body 101 by welding.

The support rod 103 is suspended from the inner wall of the water sink body 101 and the socket 111 is matched with the plug block 113. The cross section of the socket block 113 is in the shape of a dovetail, and the shape of the socket 111 matches the shape of the socket block 113.

### 6^{th} Embodiment

The invention discloses a water sink 1 comprising a water sink body 101. The water sink 1 of the present embodiment is different from the water sink of the fifth embodiment in that:

The baffle 102 includes a support rod 103. Each of the both ends of the support rod 103 adjacent to the corresponding side wall of the inner wall of the water sink body 101 comprises a connecting portion 104. The connecting portion 104 is fixedly connected to the inner wall of the water sink body 101.

The connecting portion 104 may be welded to the inner wall of the water sink body 101, or it may be locked to the inner wall of the water sink body 101 by screws, or it may be locked on the inner wall of the water sink body 101 by structures like bolts and nuts. These will not be described in detail here.

### 7^{th} Embodiment

The invention discloses a water sink 1 comprising a water sink body 101. The water sink 1 of the present embodiment is different from the water sink of the first embodiment in that:

The baffle 102 includes a support rod 103, and both ends of the support rod 103 are fixed on the inner wall of the water sink body 101. A gasket 116 is provided between the end of the support rod 103 and the inner walls of the water sink body 101.

The end of the support rod 103 is locked to the inner wall of the water sink body 101 by screws. The fixing structure of the used screw is the same as that of the first embodiment, and details are not described herein.

I claim:

1. A water sink, comprising a water sink body, wherein
each of two opposite inner walls of the water sink body has a baffle, and
both ends of the baffle are fixedly connected between the inner walls of the water sink body.

2. The water sink of claim 1, wherein space is left between the baffle and the inner wall of the corresponding water sink body.

3. The water sink of claim 2, wherein a slot for inserting a cutting board is formed between one end or both ends of the baffle and the side wall of the water sink body adjacent to an end surface of the one end or both ends.

4. The water sink of claim 1, wherein each of a front inner wall and a rear inner wall of the water sink body comprises the baffle.

5. The water sink of claim 1, wherein both ends of the baffle and the inner wall of the water sink body are fixedly connected by a connecting member.

6. The water sink of claim 1, wherein the baffle is in a “U” shape, and both ends of the baffle are respectively fixedly connected to the inner walls of the water sink body through a locking member.

7. The water sink of claim 6, wherein the baffle comprises a support rod and a connecting portion respectively disposed at each end of the support rod, the connecting portion is fixedly connected to the inner wall of the water sink body, a corner is arranged between the end of the support rod and the connecting portion, the outer side of the corner is a curved surface, and the inner side of the corner is a right angle.

8. The water sink of claim 6, wherein the baffle comprises a support rod and a connecting portion respectively disposed at each end of the support rod, the connecting portion is fixedly connected to the inner wall of the water sink body, the connecting portion is perpendicular to an end of the support rod, a side of the support rod away from the connecting portion comprises a protrusion, a cross section of the protrusion is in a triangular shape, and each of the both ends of the protrusion has a triangular slope.

9. The water sink of claim 6, wherein both ends of the baffle are arched surfaces, the baffle includes a support rod and a connecting portion provided at both ends of the support rod, the connecting portion is fixedly connected to the inner wall of the water sink body, and the connecting portion is perpendicular to the end of the support rod.

10. The water sink of claim 6, wherein the baffle comprises a support rod and a connecting portion respectively disposed at each end of the support rod, the connecting portion is fixedly connected to the inner wall of the water sink body, a corner is arranged between the end of the support rod and the connecting portion, the outer side of the corner is a slope, and the inner side of the corner is a right angle.

11. The water sink of claim 1, wherein the baffle comprises a support rod, each of the both ends of the support rod adjacent to the corresponding side wall of the inner wall of the water sink body comprises a connecting portion, and the connecting portion is detachably connected to the inner wall of the water sink body.

12. The water sink of claim 11, wherein the connecting portion has a socket on a side of the inner wall of the water sink body, the lower end of the socket has an opening, a socket block is disposed at a position on the inner wall of the water sink body corresponding to the socket, the support rod is suspended on the inner wall of the water sink body, and the socket is matched with the socket block.

13. The water sink of claim 12, wherein the socket block has a dovetail shape in cross section, and the socket has a shape that matches the shape of the socket block.

14. The water sink of claim 11, wherein each of the both ends of the support rod has an arched shape.

15. The water sink of claim 1, wherein the baffle comprises a support rod, each of the both ends of the support rod adjacent to the corresponding side wall of the inner wall of the water sink body comprises a connecting portion, and the connecting portion is fixedly connected to the inner wall of the water sink body.

16. The water sink of claim 1, wherein the baffle comprises a support rod, both ends of the support rod are fixed to the inner wall of the water sink body, and a gasket is disposed between the end of the support rod and the inner wall of the water sink body.

17. A sink-type washing machine comprising the water sink of claim 1 and a washer, the water sink being integrated with the washer.

18. The sink-type washing machine of claim 17, wherein said washing machine is a dishwasher or a fruit and vegetable washing machine.
